(19) United States
(12) Patent Application Publication
(10) Pub. No.: US 2026/0059115 A1
(43) Pub. Date: Feb. 26, 2026

(54) COMMUNICATION APPARATUS, CONTROL METHOD, AND STORAGE MEDIUM

(71) Applicant: CANON KABUSHIKI KAISHA, Tokyo (JP)

(72) Inventor: SHUN SUGIMOTO, Tokyo (JP)

(21) Appl. No.: 19/298,681

(22) Filed: Aug. 13, 2025

(30) Foreign Application Priority Data
Aug. 21, 2024 (JP) 2024-139429

(51) Int. Cl. H04N 19/146; H04W 72/1268

(52) U.S. Cl. CPC H04N 19/146; H04W 72/1268

(57) ABSTRACT

A communication apparatus includes a reception unit configured to receive uplink scheduling information notifying an uplink scheduling method from a base station, a setting unit configured to set a bit rate of a plurality of video frames using information that is different depending on the uplink scheduling method, an encoding unit configured to encode the plurality of video frames at the set bit rate, and a transmission unit configured to transmit at least one video frame in the plurality of encoded video frames to the base station.

### BACKGROUND

### Field of the Technology

The present disclosure relates to a communication apparatus, a control method, and a storage medium.

### Description of the Related Art

Cellular communication standards are designed by Third Generation Partnership Project (3GPP®). In the cellular communication standards (hereinbelow, referred to as “3GPP® standards”) by 3GPP®, standardization of an extended reality (XR), which represents virtual reality technology, is underway. Technical Report (TR) 26.928 describes various use cases related to the XR.

Use cases are not limited to the XR, but use cases for real-time video distribution utilizing the 3GPP® standards also become widespread. In these use cases, high-quality and low latency video transmission is required, and video is compressed and expanded using a video coder-decoder (codec) to reduce an amount of data to be transmitted. Video codecs include H.264/Moving Picture Experts Group (MPEG)-4 Advanced Video Coding (AVC), H.265/High Efficiency Video Coding (HEVC), and H.266/Versatile Video Coding (VVC).

A base station in a fifth generation (5G) network (hereinbelow, also referred to as a 5G base station or a next generation Node B (gNB or gNodeB)) is responsible for scheduling of uplink (UL) traffic (referred to as UL scheduling). The gNB allocates a wireless resource to each communication apparatus (also referred to as a user terminal, simply a terminal, or user equipment (UE)) based on a UL scheduling method, which is described below.

The UL scheduling method includes a dynamic scheduling (DS) method (hereinbelow, also simply referred to as DS) and a configured scheduling (CS) method (hereinbelow, also simply referred to as CS). The DS dynamically allocates a resource based on a buffer status report (BSR), which indicates an amount of data available for UL transmission from the UE, and a communication state. On the other hand, in the CS, the UE is periodically permitted to use a certain resource from the gNB and can implicitly use the resource until it receives a CS update from the gNB.

According to Japanese Patent Application Laid-Open No. 2024-47106, a technique is discussed in which a terminal that receives resource allocation by a CS and transmits a frame calculates communication fluctuation of the frame and requests a base station to change a resource allocation timing based on the calculation result.

As in the above-described conventional technique, in a case of a method in which a UE requests a gNB to control UL scheduling, whether the gNB accepts the request depends on a usage status of the gNB and other UE. Thus, there is room to study a method for setting a video frame encoding bit rate.

### SUMMARY

The present disclosure is directed to the provision of a technique for appropriately controlling a video frame encoding bit rate.

According to an aspect of the present disclosure, a communication apparatus includes a reception unit configured to receive uplink scheduling information to indicate an uplink scheduling method from a base station, a setting unit configured to set a bit rate of a plurality of video frames using information that is different depending on the uplink scheduling method, an encoding unit configured to encode the plurality of video frames at the set bit rate, and a transmission unit configured to transmit at least one video frame in the plurality of encoded video frames to the base station.

Features of the present disclosure will become apparent from the following description of embodiments with reference to the attached drawings. The following description of embodiments is described by way of example.

### BRIEF DESCRIPTION OF THE DRAWINGS

FIG. 1 is a system configuration diagram illustrating an example of a system including a communication apparatus according to an embodiment of the present disclosure.

FIG. 2 is a block diagram illustrating an example of a hardware configuration of the communication apparatus.

FIG. 3 is a block diagram illustrating an example of a functional configuration of the communication apparatus.

FIG. 4 is a flowchart illustrating an example of a processing flow from reception of uplink (UL) scheduling method information to transmission of video frame encoded data by the communication apparatus.

FIG. 5 is a flowchart illustrating an example of transmission processing for transmitting video frame encoded data performed by the communication apparatus.

FIG. 6 is a sequence diagram illustrating an example of processing by the communication apparatus and a base station in a case where a scheduling method is a dynamic scheduling (DS) method.

FIG. 7 is a sequence diagram illustrating an example of processing by the communication apparatus and a base station in a case where the scheduling method is a configured scheduling (CS) method.

### DESCRIPTION OF THE EMBODIMENTS

Embodiments of the present disclosure will be described in detail with reference to the attached drawings. The following embodiments are not meant to limit contents described in the scope of the present disclosure. A plurality of features is described in the embodiments, but not all of these features are essential to the present disclosure, and the plurality of features may be arbitrarily combined. Further, in the attached drawings, the same or similar configurations are denoted by the same reference numerals and duplicate descriptions may be omitted.

### <Configuration of System>

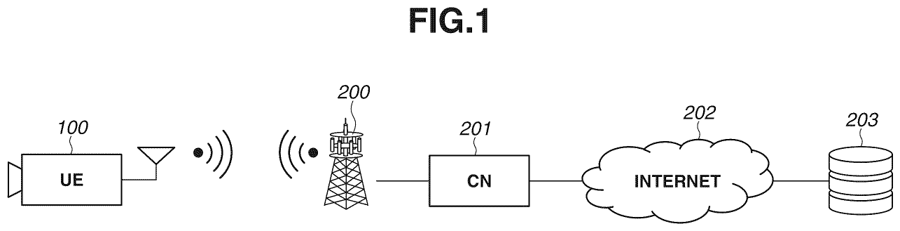

FIG. 1 is a system configuration diagram illustrating an example of a system including a communication apparatus 100 according to an embodiment of the present disclosure. The present embodiment will be described using a fifth generation (5G) system as an example, but the present disclosure is not limited to the 5G system. For example, the present disclosure may be applied to next generation mobile communication systems such as a sixth generation (6G), Long Term Evolution (LTE), LTE-Advanced (LTEA), and combinations of these.

As illustrated in FIG. 1, the present system includes the communication apparatus (hereinbelow, also referred to as user equipment (UE)) 100, a 5G base station (hereinbelow, also referred to as a next generation Node B (gNB)) 200, a 5G core network (CN) 201, an Internet 202, and a server 203. As the present system, for example, a real-time video transmission system is assumed in which video data captured by the communication apparatus 100 including an image capturing apparatus is compressed and encoded within the communication apparatus 100 and the video encoded data is transmitted in real time to the server 203 via the 5G network. In the present specification, encoding data and encoded data mean data that have been encoded.

The communication apparatus 100 communicates with the 5G CN 201 as the UE via the gNB 200. The gNB 200 is a network node that provides an access point for the UE 100 to access the CN 201. The server 203 is, for example, an extended reality (XR) application server. The video encoded data transmitted by the communication apparatus 100 is transmitted to the server 203 via the gNB 200, the CN 201, and the Internet 202. The video encoded data transmitted to the server 203 is appropriately processed by the server 203 and transmitted to the communication apparatus 100 and other communication apparatuses via the Internet 202 and the like.

### <Configuration of Communication Apparatus>

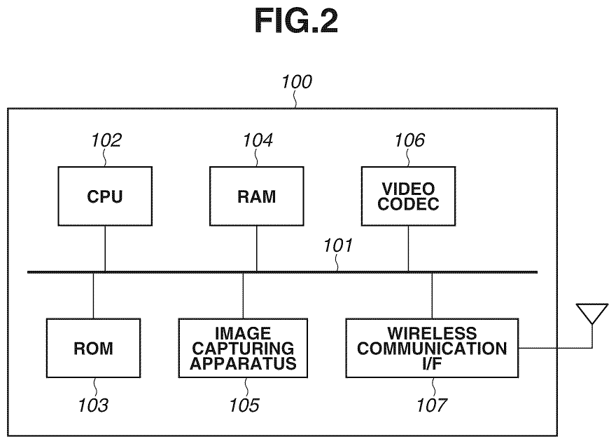

FIG. 2 is a block diagram illustrating an example of a hardware configuration of the communication apparatus 100. The communication apparatus 100 is an apparatus having a communication function, and examples of the communication apparatus 100 include a camera, a smartphone, a tablet, a personal computer (PC), a head-mounted display, and the like.

As illustrated in FIG. 2, the communication apparatus 100 includes a system bus 101, a central processing unit (CPU) 102, and a read only memory (ROM) 103. The communication apparatus 100 includes a random access memory (RAM) 104, an image capturing apparatus 105, a video coder-decoder (codec) 106 (also simply referred to as the codec 106), and a wireless communication interface (I/F) 107. The system bus 101 connects these devices 102 to 107 to each other and serves as a transfer path for various types of data between the connected devices.

The CPU 102 controls the communication apparatus 100 by comprehensively controlling the hardware devices 103 to 107 via an operating system (OS) or a device driver.

The ROM 103 stores control programs such as the OS and the device driver executed by the CPU 102.

The RAM 104 functions as a main memory and a work area and the like for the CPU 102 and can temporarily store a program and data.

The image capturing apparatus 105 is an apparatus that captures an image of an object. Video data captured by the image capturing apparatus 105 is output to the video codec 106.

The video codec 106 compresses and encodes the video data (video frame) input from the image capturing apparatus 105 according to a compression encoding method. The compression encoding method includes, for example, H.264 and H.265. In a case where the video codec 106 performs compression encoding, a target bit rate (hereinbelow, also simply referred to as a bit rate) can be set. If the target bit rate is set high, an amount of data after encoding will be larger, but video quality will be high. In contrast, if the target bit rate is set low, the amount of data after encoding will be small, but the video quality will be low. Thus, the video codec 106 encodes the video frame at the bit rate that is set as described below. Part or all of the video codec 106 may be realized by the CPU 102. Part or all of the video codec 106 may be a function realized only as software by the CPU 102. The video codec 106 is an example of an encoding unit according to the present disclosure.

The wireless communication I/F 107 is a device that realizes two-way communication with another wireless communication device (for example, the gNB 200) in the 5G network. The wireless communication I/F 107 includes hardware such as a transceiver comprising a modem and a frequency shifter and an antenna set adapted to a spectrum of a frequency transposed signal issued from a baseband modem. The wireless communication I/F 107 also includes firmware that controls establishment of communication of the communication apparatus 100 to a radio access network (RAN).

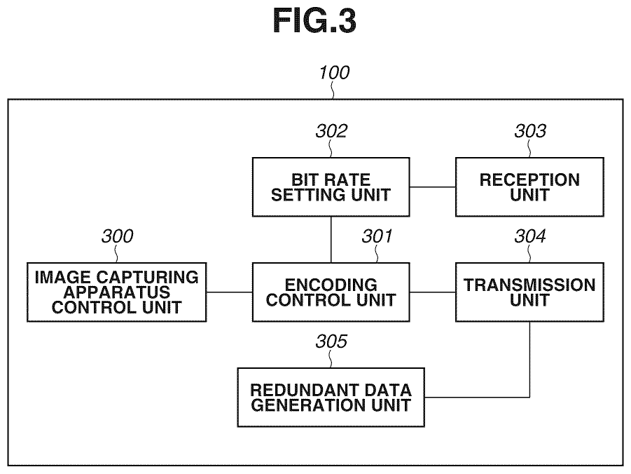

FIG. 3 is a block diagram illustrating an example of a functional configuration of the communication apparatus 100. Each function is described on the assumption that it is realized by software, but it may also be realized by hardware.

As illustrated in FIG. 3, the communication apparatus 100 includes an image capturing apparatus control unit 300, an encoding control unit 301, a bit rate setting unit 302, a reception unit 303, a transmission unit 304, and a redundant data generation unit 305.

The image capturing apparatus control unit 300 controls the image capturing apparatus 105. The image capturing apparatus control unit 300 has functions of controlling start and stop of capturing an image by the image capturing apparatus 105, setting resolution and a frame rate of video recorded by the image capturing apparatus 105, detecting a signal indicating generation of recorded video, notifying the encoding control unit 301 of video generation, and the like.

Upon receiving a video generation notification from the image capturing apparatus control unit 300, the encoding control unit 301 instructs the video codec 106 to compress and encode the video frame according to an encoding parameter including the bit rate notified from the bit rate setting unit 302. If the video codec 106 completes compression and encoding of the video frame, the encoding control unit 301 detects a signal indicating the completion of encoding from the video codec 106 and notifies the transmission unit 304 of the completion of encoding.

The bit rate setting unit 302 calculates (sets) the bit rate using information about an uplink (UL) scheduling method and information about an allocated resource block from the reception unit 303. The information about the UL scheduling method is also referred to as UL scheduling method information, and the information about the allocated resource block is also referred to as allocated resource block information. These pieces of information are collectively referred to as information about UL scheduling or UL scheduling information. Specifically, the information about the UL scheduling is configured scheduling (CS) information by a radio resource control (RRC) message or a UL Grant, which are described in detail below. The bit rate setting unit 302 calculates (sets) the bit rates of a plurality of video frames using information different depending on the UL scheduling method. The bit rate setting unit 302 notifies the encoding control unit 301 of the calculated bit rate. A method for calculating the bit rate is described below. The bit rate setting unit 302 is an example of a setting unit according to the present disclosure.

The reception unit 303 controls the wireless communication I/F 107 to receive the UL scheduling method information and the information about the allocated resource block from the gNB 200 and outputs these pieces of information to the bit rate setting unit 302. The UL scheduling method information and the allocated resource block information (collectively referred to as the UL scheduling information) are information that are different depending on the UL scheduling method and thus are information that notify the UL scheduling method as described below. For example, in a case of a dynamic scheduling (DS) method, the reception unit 303 receives the UL Grant including UL allocated resource information from the gNB 200 as the UL scheduling information via a physical downlink control channel (PDCCH). In a case of a CS method, the reception unit 303 receives the CS information including periodicity information indicating a period of a configured UL Grant (configured grant) from the gNB 200 as the UL scheduling information by the RRC message. More specifically, the CS information includes information indicating whether a period of a transmission opportunity allocated to the communication apparatus 100 or a resource block allocated to the communication apparatus 100 is constant for a predetermined period. Thus, the reception unit 303 monitors a channel so that it can receive information (messages) related to both the DS method and the CS method. The reception unit 303 also executes reception protocol processing according to a communication protocol to be used. The reception unit 303 is an example of a reception unit according to the present disclosure.

The transmission unit 304 controls the wireless communication I/F 107 to transmit a message and data to the gNB 200. When video transmission is started, the transmission unit 304 transmits a scheduling request (SR) indicating a UL data transmission request to the gNB 200 via a physical uplink control channel (PUCCH). The transmission unit 304 transmits the video frame encoded data to the gNB 200 via a physical uplink shared channel (PUSCH).

The redundant data generation unit 305 generates redundant data with respect to the video frame encoded data generated by the video codec 106. The redundant data may be data, such as an error correction code, that enables a receiving side to detect and restore loss or damage of the video frame encoded data during communication or dummy data without error correction capability. The redundant data is data for using up a resource block bandwidth allocated by the gNB 200.

### <Operation of System>

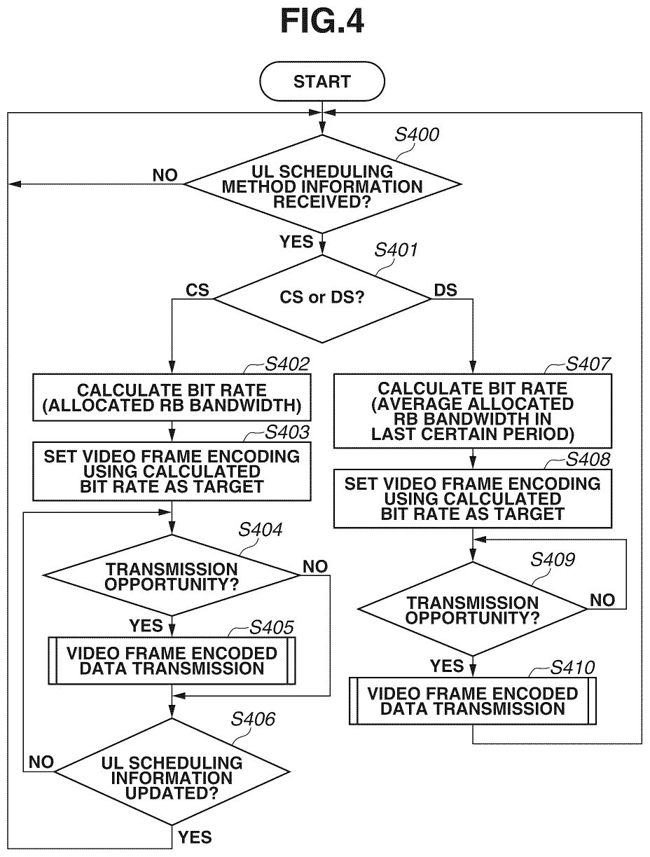

FIG. 4 is a flowchart illustrating an example of a processing flow from reception of UL scheduling method information by the communication apparatus 100 (the reception unit 303) to transmission of video frame encoded data by the communication apparatus 100 (the transmission unit 304). The flowchart illustrates an overall processing flow, and each function (step) may be operated in parallel.

In step S400, the reception unit 303 waits until it receives the UL scheduling method information from the gNB 200.

In a case where the UL scheduling method information is received (YES in step S400), in step S401, the bit rate setting unit 302 determines the UL scheduling method from the UL scheduling method information. As described with reference to FIG. 3, the UL scheduling method information is different depending on the UL scheduling method. In a case where the reception unit 303 receives the UL Grant via the PDCCH, the bit rate setting unit 302 determines that the UL scheduling method is the DS method (DS in step S401), and the processing proceeds to step S407. On the other hand, in a case where the reception unit 303 receives the CS information by the RRC message, the bit rate setting unit 302 determines that the UL scheduling method is the CS method (CS in step S401), and the processing proceeds to step S402.

In step S402, the bit rate setting unit 302 calculates the bit rate in the CS method. In the CS method, the bit rate setting unit 302 calculates the bit rate based on the periodicity information and the allocated resource block information in the configured UL Grant notified by the RRC message, other antenna setting, 5G communication setting, and the like. The periodicity information is an example of information about the period of the transmission opportunity allocated to the communication apparatus 100, and the allocated resource block information is an example of information about the resource block allocated to the communication apparatus 100.

The bit rate setting unit 302 calculates, as the bit rate, an allocated resource block bandwidth (an example of an available bandwidth according to the present disclosure) calculated by multiplying the ratio of time slots periodically allocated from the total resource block bandwidth. As a specific example, the bit rate setting unit 302 calculates the total resource block bandwidth (bps) according to, for example, the following Expression 1.

$$( Number of MIMO layers ) * ( number of modulation symbol bits ) * ( maximum encoding rate ) * ( number of resource blocks ) * ( number of subcarriers ) / ( OFDM symbol time length ( second ) ) * ( 1 - ( wireless frame overhead rate ) ) * ( UL allocation ratio ) \qquad ( Expression 1 )$$

The “number of multiple input multiple output (MIMO) layers” in the UL of the communication apparatus 100 depends on the number of antennas, but in a case of a single user MIMO (SU-MIMO), the number is a maximum of four layers.

The “number of modulation symbol bits” is the number of bits per modulation symbol, and is, for example, 6 bits for 64 quadrature amplitude modulation (QAM).

The “maximum encoding rate” is a ratio of data in encoded bit, and for example, maximum is 948/1024 for a low density parity check (LDPC) code.

The “number of resource blocks” is the number of resource blocks per component carrier, and is, for example, 132 for a 28 GHz band with a subcarrier spacing of 120 kHz and a component carrier width of 200 MHz.

The “number of subcarriers” is the number of subcarriers that form one resource block, and is, for example, 12.

The “orthogonal frequency division multiplexing (OFDM) symbol time length” is a time length per OFDM symbol and is, for example, 8.93 microseconds (0.00000893 seconds) in a case of the subcarrier spacing of 120 KHz.

The “wireless frame overhead rate” is an overhead rate per wireless frame and is, for example, about 0.2 for a millimeter wave.

The “UL allocation ratio” is a UL ratio in time division duplex (TDD) and is, for example, 0.2 when downlink (DL):UL is 4:1.

For example, in a case where each parameter has the above-described value, the total resource block bandwidth is calculated as 4*6*948/1024*132*12/0.00000893*(1−0.2)*0.2, which is approximately 630 Mbps.

For example, it is assumed that the resource is allocated in a one slot period out of ten UL slots based on the periodicity information included in the CS information. In this case, the bit rate setting unit 302 calculates the allocated resource block bandwidth of 63 Mbps by multiplying the total resource block bandwidth 630 Mbps by 1/10 as the bit rate.

In step S403, the encoding control unit 301 performs a video frame encoding setting on the video codec 106 using the bit rate calculated in step S402 as a target bit rate.

In step S404, the transmission unit 304 waits for the transmission opportunity for the video frame encoded data by determining the transmission opportunity for the video frame encoded data according to the periodicity defined by the RRC message.

In a case where the transmission opportunity for transmitting the video frame encoded data does not come (NO in step S404), in step S406, the reception unit 303 monitors the PDCCH for whether the UL scheduling information is updated. In a case where the UL scheduling information is updated (YES in step S406), the processing returns to step S400, whereas in a case where the UL scheduling information is not updated (NO in step S406), the processing returns to step S404.

In step S404, in a case where the transmission opportunity for transmitting the video frame encoded data comes (YES in step S404), the processing proceeds to step S405. In step S405, the transmission unit 304 performs transmission processing for transmitting the video frame encoded data. The transmission processing for transmitting the video frame encoded data in step S405 is described in detail below.

In step S407, the bit rate setting unit 302 calculates the bit rate in the DS method. In the DS method, the bit rate setting unit 302 also calculates the total resource block bandwidth according to, for example, the calculation formula described in Expression 1 in the same manner as in step S402. Next, the bit rate setting unit 302 calculates the allocated resource block bandwidth by multiplying the calculated total resource block bandwidth by a ratio of the number of time slots allocated in the UL Grant to the total number of time slots. The number of time slots allocated in the UL Grant is an example of information about the resource block allocated to the communication apparatus 100. For example, in a case where the total resource block bandwidth is 630 Mbps and two slots out of ten UL slots are allocated, the allocated resource block bandwidth is 126 Mbps.

The bit rate is calculated using the allocated resource block bandwidth. For example, the bit rate setting unit 302 calculates, as the bit rate, an average value of the allocated resource block bandwidth calculated using the information about the resource block received during a last certain period (for example, a certain period of time from the present to the past).

In addition, the bit rate setting unit 302 may calculate, as the bit rate, a minimum value of the allocated resource block bandwidth calculated using the information about the resource block received during the last certain period (for example, a certain period of time from the present to the past).

The bit rate setting unit 302 may calculate, as the bit rate, a value obtained by multiplying the allocated resource block bandwidth calculated using the information about the most recently received (latest) resource block by a predetermined ratio (for example, 0.8).

In this case, the bit rate setting unit 302 may adaptively change the ratio by which the calculated allocated resource block bandwidth is multiplied according to the communication state with the gNB 200 (for example, received power and reception quality). In other words, the above-described predetermined ratio may be changed according to the communication state between the communication apparatus 100 and the gNB 200. For example, in a case where the communication state is good (for example, in a case where a received power value or the like is a predetermined threshold value or more), the bit rate setting unit 302 may calculate a value obtained by multiplying the calculated allocated resource block bandwidth by a first ratio (for example, 0.8) as the bit rate. In a case where the communication state is poor (for example, in a case where the received power value or the like is less than the threshold value), the bit rate setting unit 302 may calculate a value obtained by multiplying the calculated allocated resource block bandwidth by a second ratio (for example, 0.7) that is smaller than the first ratio as the bit rate. An example is described in which two ratios, one for the good communication state and one for the poor communication state, are used, but more detailed ratios, i.e., three or more ratios, may be used. In a case where three or more ratios are used, two or more corresponding threshold values may be set. Accordingly, the bit rate can be more appropriately controlled according to the communication state.

In step S408, the encoding control unit 301 performs the video frame encoding setting on the video codec 106 using the bit rate calculated in step S407 as the target bit rate.

In step S409, the transmission unit 304 waits for the transmission opportunity for transmitting the video frame encoded data by determining the transmission opportunity for transmitting the video frame encoded data based on the allocated time slot indicated by the UL Grant.

In a case where the transmission opportunity for the video frame encoded data comes (YES in step S409), the processing proceeds to step S410. In step S410, the transmission unit 304 performs transmission processing for transmitting the video frame encoded data. The transmission processing for transmitting the video frame encoded data in step S410 is the same as the transmission processing for transmitting the video frame encoded data in step S405. Subsequently, the processing proceeds to step S400 and the communication apparatus 100 waits for resource allocation by the next UL Grant.

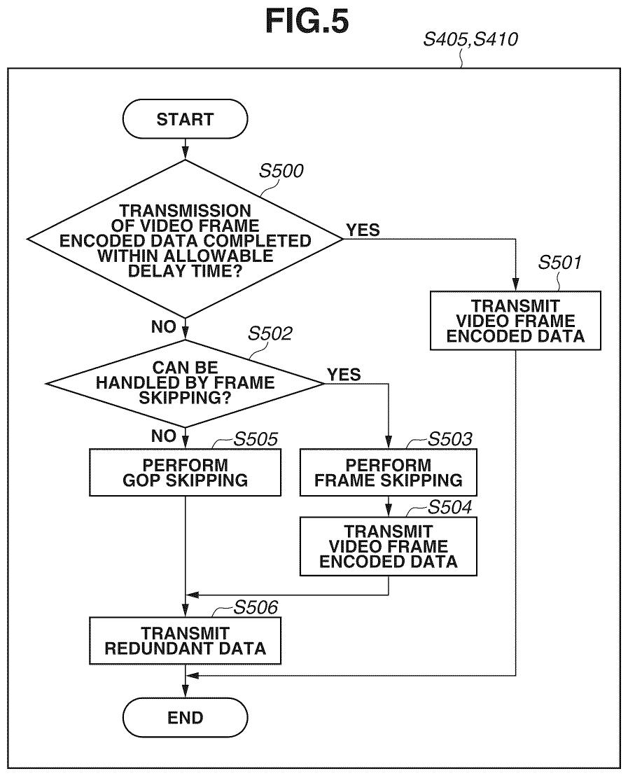

FIG. 5 is a flowchart illustrating an example of the transmission processing for transmitting the video frame encoded data (in steps S405 and S410 in FIG. 4) performed by the communication apparatus 100 (the transmission unit 304). According to the present embodiment, the transmission processing for transmitting the video frame encoded data illustrated in FIG. 5 is performed in units of group of pictures (GOP). However, the unit for performing the transmission processing is not limited to the GOP.

In step S500, the transmission unit 304 determines whether the transmission of the video frame encoded data is completed within an allowable delay time that is predetermined in the system. For example, in a case where transmission of buffered video frame encoded data is not completed within the current transmission opportunity, the video frame encoded data is transmitted also in the next transmission opportunity, and a transmission delay occurs. In a case where the transmission delay is within the allowable delay time (in a case where the transmission of the video frame encoded data is completed within a predetermined time, YES in step S500), the processing proceeds to step S501, whereas in a case where the transmission delay exceeds the allowable delay time (NO in step S500), the processing proceeds to step S502.

In step S501, the transmission unit 304 transmits the video frame encoded data to the gNB 200 and completes the transmission processing.

In step S502, the transmission unit 304 determines whether the transmission delay can be dealt with by frame skipping of the video frame encoded data. Frame skipping is a method for reducing an amount of data to be transmitted by not transmitting all of the encoded video frames but canceling transmission of some video frames. However, in a case of the encoding method involving interframe prediction represented by H.264 and H.265, a dependency relationship occurs between frames in decoding data, so that the number of frames that can be skipped is limited. For example, a frame configuration is assumed in which a first frame is an intra-frame (I frame), followed by alternating predictive frames (P frames) and bidirectional predictive frames (B frames) in video frame data of 60 frames per GOP. An I frame is intra-frame encoded and does not refer to other frames, so that decoding is completed within the frame. P and B frames are inter-frame encoded and refer to other frames in encoding, and thus refer to the other frame data that is referred to during encoding also in decoding. The difference between the P frame and the B frame is whether a reference direction is one direction (P frame) or two directions (B frame). In this case, it is assumed that the P frame refers to a preceding I frame or P frame, and the B frame refers to an immediately preceding P frame and an immediately following P frame. However, it goes without saying that determination and skipping described below can be performed in the same manner even with other references. In such a GOP configuration, determination as to whether the transmission delay can be dealt with by frame skipping is performed in two stages. First, the transmission unit 304 determines whether the transmission can be completed within the allowable delay time by skipping the B frame that is not referred to in decoding of other frames. In a case where skipping the B frame alone is not sufficient, then, the transmission unit 304 determines whether the transmission can be completed within the allowable delay time by skipping the B frame and the P frame in a second stage. In a case where it is determined that the transmission is completed within the allowable delay time in either of these two stages of determination (YES in step S502), the processing proceeds to step S503. On the other hand, in a case where it is determined that the transmission is not completed within the allowable delay time in both the two stages of determination (NO in step S502), the processing proceeds to step S505.

In step S503, the transmission unit 304 performs frame skipping using a method determined in step S502 to complete the transmission within the allowable delay time. As described above, in a case where (it is determined that) the transmission of the encoded video frame is not completed within the predetermined time, the transmission unit 304 cancels transmission of one or a plurality of video frames in these video frames. At this time, the transmission unit 304 determines one or a plurality of video frames of which transmission is to be cancelled based on a reference relationship between these video frames.

In step S504, the transmission unit 304 transmits the video frame encoded data that is not frame skipped in step S503 to the gNB 200.

In step S505, the transmission unit 304 skips the entire GOP and cancels its transmission.

In step S506, the transmission unit 304 transmits the redundant data generated by the redundant data generation unit 305 to fully use the resource blocks allocated in the current transmission opportunity.

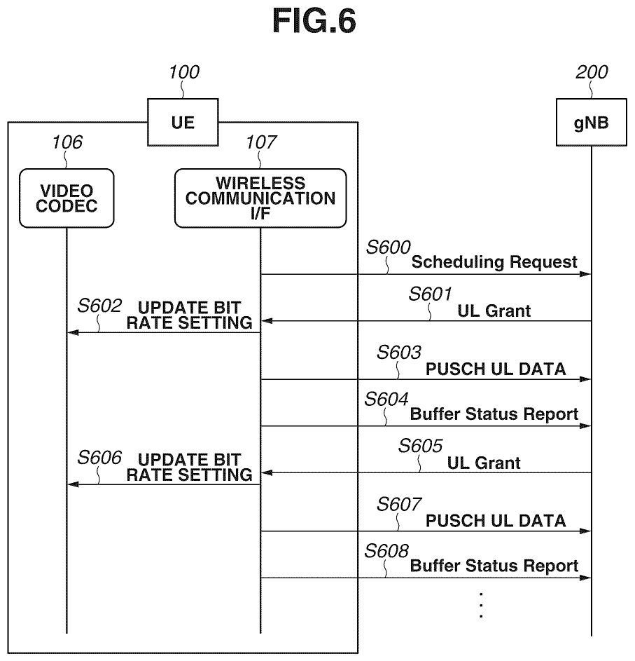

FIG. 6 is a sequence diagram illustrating an example of processing by the communication apparatus 100 and the gNB 200 in a case where the scheduling method is the DS method.

In step S600, the communication apparatus 100 transmits a scheduling request indicating an uplink data transmission request to the gNB 200 in starting video transmission.

In step S601, the gNB 200 transmits the UL Grant to the communication apparatus 100.

In step S602, in a case where the wireless communication I/F 107 receives the UL Grant, the bit rate setting unit 302 calculates the bit rate, and the encoding control unit 301 updates the bit rate setting of the video codec 106.

Subsequently, in step S603, the communication apparatus 100 transmits the video frame encoded data to the gNB 200 as the UL data via the PUSCH. The video frame encoded data to be transmitted is not necessarily encoded at the bit rate set and updated in step S602 and may be encoded at the bit rate set before step S602.

Next, in step S604, the communication apparatus 100 transmits a buffer status report (BSR) that notifies how much the video frame encoded data accumulates in a buffer (referred to as a buffer retention data amount) to the gNB 200.

In step S605, the gNB 200 transmits the next UL Grant with the resource block allocated thereto to the communication apparatus 100 according to the buffer retention data amount notified in the BSR.

Subsequently, bit rate setting update (in step S606), UL data transmission (in step S607), and BSR transmission (in step S608) are repeated until the video transmission from the communication apparatus 100 to the server 203 is completed.

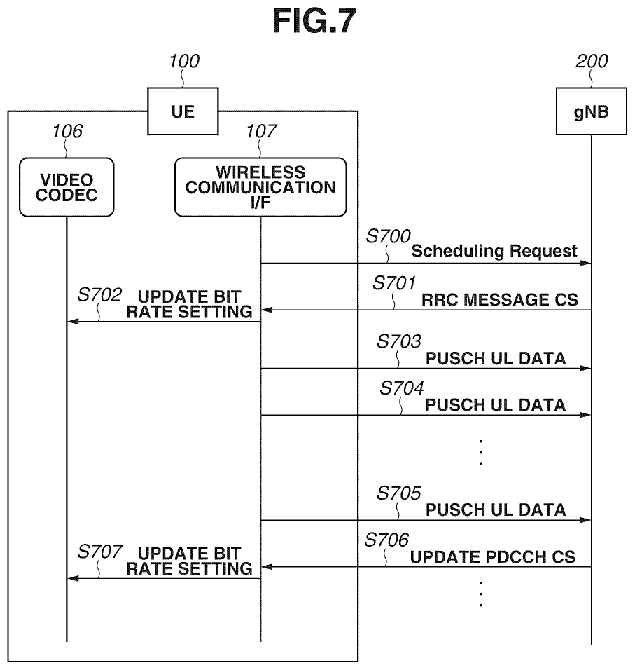

FIG. 7 is a sequence diagram illustrating an example of processing performed by the communication apparatus 100 and the gNB 200 in a case where the scheduling method is the CS method.

In step S700, the communication apparatus 100 transmits a scheduling request indicating an uplink data transmission request to the gNB 200 in starting video transmission as in step S600.

In step S701, the gNB 200 transmits the CS information to the communication apparatus 100 via the RRC message.

In step S702, in a case where the wireless communication I/F 107 receives the CS information, the bit rate setting unit 302 calculates the bit rate, and the encoding control unit 301 updates the bit rate setting of the video codec 106.

Subsequently, in step S703, the communication apparatus 100 transmits the video frame encoded data to the gNB 200 as the UL data via the PUSCH.

In steps S704 and S705, in a case where the UL scheduling method is the CS method, the communication apparatus 100 continues to transmit the video frame encoded data to the gNB 200 according to the periodicity information defined in the CS information. In a case where the UL scheduling method is the CS method, the communication apparatus 100 transmits the video frame encoded data to the gNB 200 without receiving resource allocation information from the gNB 200.

In step S706, the gNB 200 transmits a CS information update notification to the communication apparatus 100 via the PDCCH.

In step S707, in a case where the wireless communication I/F 107 receives the CS information update notification, the bit rate setting unit 302 calculates the bit rate, and the encoding control unit 301 updates the bit rate setting to the video codec 106.

Subsequently, the communication apparatus 100 continues to transmit the video frame encoded data according to the periodicity information included in the updated CS information until the video transmission from the communication apparatus 100 to the server 203 is completed or the communication apparatus 100 again receives the CS information update notification.

As described above, according to the present embodiment, the communication apparatus 100 changes a method for setting a video frame encoding bit rate (information used for bit rate setting) depending on the UL scheduling method (whether the UL scheduling method is the DS method or the CS method). Accordingly, it is possible to appropriately control the video frame encoding bit rate without depending on the gNB and other communication apparatuses.

According to the present disclosure, in a case where the UL scheduling method is the DS method, it is possible to reduce a possibility that the target bit rate of the video frame encoding is set without considering a possibility that the number of transmission opportunities and resources allocated may dynamically decrease due to deterioration of the communication state and data transmission delay and data discard are caused.

According to the present disclosure, in a case where the UL scheduling method is the CS method, it is possible to reduce a possibility that the target bit rate is set low in preparation for a decrease in the number of transmission opportunities and resources allocated, the resource in the transmission opportunity is not effectively and fully used and the video quality is deteriorated.

In step S500 in FIG. 5, in a case where it is determined that the transmission of the video frame encoded data is not completed within the allowable delay time, re-encoding may be performed instead of the above-described processing. In this case, the encoding control unit 301 may instruct the video codec 106 to perform compression and encoding at a bit rate lower than the bit rate set immediately before (for example, a value obtained by multiplying the bit rate set immediately before by 0.9, 0.8, or the like). Thus, in this case, the video codec 106 may encode the video frame at a bit rate lower than the bit rate set immediately before. In a case where it is determined that the transmission is not completed within the allowable delay time even if re-encoding is performed, such re-encoding may be recursively performed.

Regarding the DS method, according to the above-described embodiment, an example is described in which the bit rate setting unit 302 calculates the bit rate using the information about the resource block received during the last certain period, but the present disclosure is not limited to this example. For example, the bit rate setting unit 302 may calculate, as the bit rate, an average value of the allocated resource block bandwidths calculated using information about N consecutive resource blocks received up to the current time, including information about the most recently received resource block. Similarly, the bit rate setting unit 302 may calculate, as the bit rate, a minimum value of the allocated resource block bandwidths calculated using the information about the N consecutive resource blocks received up to the current time, including the information about the most recently received resource block. N is a predetermined integer of 2 or more, such as 5 or 10.

Regarding the DS method, according to the above-described and other embodiments, several methods for calculating the bit rate are described. The communication apparatus 100 may determine which calculation method to use from among some or all of these calculation methods based on, for example, the communication state (received power, reception quality, and the like). In this case, for example, in a case where the communication state is poor, the communication apparatus 100 may use a calculation method that can minimize the bit rate to calculate the bit rate. Alternatively, the gNB 200 may set or notify the communication apparatus 100 which calculation method to use from among some or all of these calculation methods. In this case, for example, the gNB 200 may perform setting or notification using an RRC message (RRC signaling), a medium access control (MAC) control element (CE), and/or downlink control information (DCI).

The present disclosure can also be realized by processing of supplying a program for implementing one or more functions of the above-described embodiments to a system or an apparatus via a network or a storage medium and causing one or more processors in a computer of the system or the apparatus to read and execute the program. The present disclosure can also be realized by a circuit (e.g., an application specific integrated circuit (ASIC) or a field programmable gate array (FPGA)) that realizes one or more functions.

Arbitrary two or more components of the above-described communication apparatus 100 may be integrated, or one component may be divided into two or more (sub) components. For example, the encoding control unit 301 and the bit rate setting unit 302 (and the video codec 106, if necessary) may be integrated into one component.

Names of the components, parameters, and the like of the above-described communication apparatus 100 are merely examples and may be changed to other names.

Orders in the processing procedures, sequences, flowcharts, and the like of the above-described embodiments may be changed as long as there is no contradiction. For example, the above-described methods present elements of various steps using an exemplary order and are not limited to the presented specific order.

For example, the order of steps S700 and S701 in FIG. 7 may be changed. In the processing procedures, sequences, flowcharts, and the like of the above-described embodiments, some steps may not be present, or additional steps may be present. For example, step S700 in FIG. 7 may not be present.

Regarding the above-described embodiments, the following supplementary notes are further disclosed.

### [Supplementary Note 1]

A communication apparatus includes:
a reception unit configured to receive uplink scheduling information notifying an uplink scheduling method from a base station;
a setting unit configured to set a bit rate of a plurality of video frames using information that is different depending on the uplink scheduling method;
an encoding unit configured to encode the plurality of video frames at the set bit rate; and
a transmission unit configured to transmit at least one video frame in the plurality of encoded video frames to the base station.

### [Supplementary Note 2]

The communication apparatus according to the supplementary note 1, wherein, in a case where the uplink scheduling method is a configured scheduling method, the uplink scheduling information includes information about a period of a transmission opportunity allocated to the communication apparatus and information about a resource block allocated to the communication apparatus.

### [Supplementary Note 3]

The communication apparatus according to the supplementary note 2, wherein the setting unit sets the bit rate based on an available bandwidth that is calculated using the information about the period of the transmission opportunity and the information about the resource block.

### [Supplementary Note 4]

The communication apparatus according to any one of the supplementary notes 1 to 3, wherein, in a case where the uplink scheduling method is a dynamic scheduling method, the uplink scheduling information includes information about a resource block allocated to the communication apparatus.

### [Supplementary Note 5]

The communication apparatus according to the supplementary note 4, wherein the setting unit sets the bit rate based on an average value of available bandwidths that is calculated using information about a resource block received during a certain period of time from the present to the past.

### [Supplementary Note 6]

The communication apparatus according to the supplementary note 4 or 5, wherein the setting unit sets the bit rate based on a minimum value of an available bandwidth that is calculated using information about a resource block received during a certain period of time from the present to the past.

### [Supplementary Note 7]

The communication apparatus according to any one of the supplementary notes 4 to 6, wherein the setting unit sets the bit rate based on a value obtained by multiplying an available bandwidth that is calculated using information about a resource block received most recently by a predetermined ratio.

### [Supplementary Note 8]

The communication apparatus according to the supplementary note 7, wherein the predetermined ratio changes according to a communication state between the communication apparatus and the base station.

### [Supplementary Note 9]

The communication apparatus according to any one of the supplementary notes 1 to 8, wherein, in a case where transmission of the plurality of encoded video frames to the base station is not completed within a predetermined time, the transmission unit cancels transmission of video frames excluding the one or more video frames in the plurality of encoded video frames.

### [Supplementary Note 10]

The communication apparatus according to the supplementary note 9, wherein the transmission unit determines video frames excluding the one or more video frames in the plurality of encoded video frames based on a reference relationship between the plurality of video frames.

### [Supplementary Note 11]

A method of control performed by a communication apparatus, wherein the method includes:
receiving uplink scheduling information notifying an uplink scheduling method from a base station;
setting a bit rate of a plurality of video frames using information that is different depending on the uplink scheduling method;
encoding the plurality of video frames at the set bit rate; and
transmitting at least one video frame in the plurality of encoded video frames to the base station.

### [Supplementary Note 12]

A non-transitory computer-readable storage medium that stores a program causing a computer included in a communication apparatus to perform:
receiving uplink scheduling information notifying an uplink scheduling method from a base station;
setting a bit rate of a plurality of video frames using information that is different depending on the uplink scheduling method;
encoding the plurality of video frames at the set bit rate; and
transmitting at least one video frame in the plurality of encoded video frames to the base station.

According to an aspect of the present disclosure, a video frame encoding bit rate can be appropriately controlled.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-139429, filed Aug. 21, 2024, which is hereby incorporated by reference herein in its entirety.

What is claimed is:

1. A communication apparatus comprising:
a reception unit configured to receive uplink scheduling information notifying an uplink scheduling method from a base station;
a setting unit configured to set a bit rate of a plurality of video frames using information that is different depending on the uplink scheduling method;
an encoding unit configured to encode the plurality of video frames at the set bit rate; and
a transmission unit configured to transmit at least one video frame in the plurality of encoded video frames to the base station.

2. The communication apparatus according to claim 1, wherein, in a case where the uplink scheduling method is a configured scheduling method, the uplink scheduling information includes information about a period of a transmission opportunity allocated to the communication apparatus and information about a resource block allocated to the communication apparatus.

3. The communication apparatus according to claim 2, wherein the setting unit sets the bit rate based on an available bandwidth that is calculated using the information about the period of the transmission opportunity and the information about the resource block.

4. The communication apparatus according to claim 1, wherein, in a case where the uplink scheduling method is a dynamic scheduling method, the uplink scheduling information includes information about a resource block allocated to the communication apparatus.

5. The communication apparatus according to claim 4, wherein the setting unit sets the bit rate based on an average value of available bandwidths that is calculated using information about a resource block received during a certain period of time from the present to the past.

6. The communication apparatus according to claim 4, wherein the setting unit sets the bit rate based on a minimum value of an available bandwidth that is calculated using information about a resource block received during a certain period of time from the present to the past.

7. The communication apparatus according to claim 4, wherein the setting unit sets the bit rate based on a value obtained by multiplying an available bandwidth that is calculated using information about a resource block received most recently by a predetermined ratio.

8. The communication apparatus according to claim 7, wherein the predetermined ratio changes according to a communication state between the communication apparatus and the base station.

9. The communication apparatus according to claim 1, wherein, in a case where transmission of the plurality of encoded video frames to the base station is not completed within a predetermined time, the transmission unit cancels transmission of video frames excluding the one or more video frames in the plurality of encoded video frames.

10. The communication apparatus according to claim 9, wherein the transmission unit determines video frames excluding the one or more video frames in the plurality of encoded video frames based on a reference relationship between the plurality of video frames.

11. A method of control performed by a communication apparatus, the method comprising:
receiving uplink scheduling information notifying an uplink scheduling method from a base station;
setting a bit rate of a plurality of video frames using information that is different depending on the uplink scheduling method;
encoding the plurality of video frames at the set bit rate; and
transmitting at least one video frame in the plurality of encoded video frames to the base station.

12. A non-transitory computer-readable storage medium that stores a program causing a computer included in a communication apparatus to perform:
receiving uplink scheduling information notifying an uplink scheduling method from a base station;
setting a bit rate of a plurality of video frames using information that is different depending on the uplink scheduling method;
encoding the plurality of video frames at the set bit rate; and
transmitting at least one video frame in the plurality of encoded video frames to the base station.
